(19) United States
(12) Patent Application Publication
(10) Pub. No.: US 2024/0354648 A1
(43) Pub. Date: Oct. 24, 2024

(54) SYSTEMS AND METHODS FOR USING SYNTHETIC DATA TO TRAIN MACHINE LEARNING MODELS

(71) Applicant: RELATIVITY ODA LLC, Chicago, IL (US)

(72) Inventors: Evan Curtin, Brooklyn, NY (US); Aron Ahmadia, Arlington, VA (US); Nathan Reff, Rocheste, NY (US); Elise Tropiano, Evanston, IL (US)

(21) Appl. No.: 18/640,301

(22) Filed: Apr. 19, 2024

Related U.S. Application Data
(60) Provisional application No. 63/461,155, filed on Apr. 21, 2023.

(51) Int. Cl. G06N 20/00

(52) U.S. Cl. CPC G06N 20/00

(57) ABSTRACT

Systems, methods, and computer readable media for generating synthetic training data to train a machine learning model are provided. The techniques may relate to ensuring that confidential customer data is not used to train a partially-trained model that is provided to a second customer. Accordingly, the techniques may include presenting a user interface coupled to a large language model (LLM) to detect a request to generate example synthetic data having one or more characteristics. The techniques may further include presenting the example synthetic data to a user to detect feedback on the example synthetic data. Based on the feedback, the LLM may generate additional synthetic data. The techniques may then embed the synthetic data to generate an embedding space for training a machine learning model.

### CROSS-REFERENCE TO RELATED APPLICATIONS

This application claims priority to U.S. provisional patent application No. 63/461,155, filed on Apr. 21, 2023, entitled “SYSTEMS AND METHODS FOR USING SYNTHETIC DATA TO TRAIN MACHINE LEARNING MODELS” the entire disclosure of which is hereby incorporated herein by reference.

### FIELD OF THE DISCLOSURE

The present disclosure relates generally to using synthetic data to train machine learning models, and more particularly to techniques that enable portability of machine learning models without exposing confidential customer data.

### BACKGROUND

In the eDiscovery process commonly associated with litigation, for example, reviewers (e.g., attorneys) are commonly provided with a voluminous corpus of documents (e.g., emails, SMS communications, group texts, presentations, reports, spreadsheets, etc.) that conform to a discovery request. Thus, rather than manually each document in the corpus, eDiscovery processes commonly deploy machine learning models to identify documents responsive to an inquiry (e.g., identifying privileged documents, documents responsive to a discovery request, etc.). To trust the classifications applied by the machine learning models, the models must first be trained on a set of manually annotated documents.

This manual review process is time consuming and expensive. Accordingly, one way to reduce the amount of manual review required is to start the training process with a partially-trained and/or portable machine learning model. Generally, when starting with a partially-trained model, fewer manually-annotated documents are needed to train the machine learning model to satisfy the validation requirements associated with having sufficient confidence that the machine learning model will properly classify the un-annotated documents in the corpus. While the foregoing described training a machine learning model to classify the documents, similar improvements may be attained for machine learning models used to search the corpus of documents.

In the eDiscovery context, the corpus of documents often includes confidential information that cannot be exposed to third parties. If the confidential information is used to train the partially-trained and/or portable models, it may be possible to for sophisticated parties derive characteristics about the documents used to train the model. Thus, there is a risk that using client confidential data to pre-train the machine learning models breaks the confidentiality requirements.

Accordingly, there is a need to incorporate privacy by design into the process of generating partially-trained and/or portable models to reduce the amount of manual annotations needed to train machine learning models that act upon client confidential data. Said another way, there is a need for systems and method for using synthetic data to train machine learning models.

### BRIEF SUMMARY

In one embodiment, a method for generating synthetic data to train a machine learning model is provided. The method may include (1) presenting, via one or more processors, a user interface coupled to a large language model (LLM) via which a user interfaces with the LLM; (2) detecting, via the user interface, a request to generate synthetic data, the request indicating one or more characteristics of the synthetic data; (3) inputting, via the one or more processors, the request into the LLM to generate example synthetic data having the one or more characteristics; (4) presenting, via the user interface, the example synthetic data; (5) detecting, via the user interface, feedback on the example synthetic data; (6) causing, via the one or more processors, the LLM to generate additional synthetic data based upon the feedback; and (7) embedding, via the one or more processors, the additional synthetic data to generate an embedding space for training a classifier.

In another embodiment, a system for generating synthetic data to train a machine learning model is provided. The system includes (i) one or more processors, and (ii) one or more memories storing non-transitory, computer-readable instructions. The instructions, when executed by the one or more processors, cause the system to (1) present a user interface coupled to a large language model (LLM) via which a user interfaces with the LLM; (2) detect, via the user interface, a request to generate synthetic data, the request indicating one or more characteristics of the synthetic data; (3) input the request into the LLM to generate example synthetic data having the one or more characteristics; (4) present the example synthetic data; (5) detect, via the user interface, feedback on the example synthetic data; (6) cause the LLM to generate additional synthetic data based upon the feedback; and (7) embed the additional synthetic data to generate an embedding space for training a classifier.

In yet another embodiment, a non-transitory computer-readable storage medium storing processor-executable instructions is provided. The instructions, when executed cause one or more processors to (1) present a user interface coupled to a large language model (LLM) via which a user interfaces with the LLM; (2) detect, via the user interface, a request to generate synthetic data, the request indicating one or more characteristics of the synthetic data; (3) input the request into the LLM to generate example synthetic data having the one or more characteristics; (4) present the example synthetic data; (5) detect, via the user interface, feedback on the example synthetic data; (6) cause the LLM to generate additional synthetic data based upon the feedback; and (7) embed the additional synthetic data to generate an embedding space for training a classifier.

### BRIEF DESCRIPTION OF THE DRAWINGS

FIG. 1 illustrates an example environment that may be used to implement the disclosed techniques, according to an embodiment;

FIG. 2 illustrates an example design system at which the generative AI techniques may be implemented, according to an embodiment;

FIG. 3 illustrates an example design system, according to an embodiment;

FIG. 4 illustrates an example user interface for generating synthetic data, according to an embodiment; ands

FIG. 5 illustrates an example computer-implemented method for using synthetic data to train a model, according to one embodiment.

### DETAILED DESCRIPTION

### I. Overview

The present techniques relate to the usage of one or more document models to using a large language model (LLM) to generate synthetic data to train a machine learning model. As it is used herein, the term LLM refers to generative machine learning models that are able to receive natural language inputs and output data responsive to the natural language inputs. Commonly, a LLM may be used to generate text outputs. That said, a LLM may be used to generate data in any format, including the formats described herein. It should be appreciated that the specific machine learning models that operate in conjunction to form the LLM may vary from implementation to implementation and over time as the state of generative artificial intelligence (AI) improves over time. Regardless, the techniques disclosed herein may be applied to any suitable LLM that is able to generate data in accordance with the disclosed techniques.

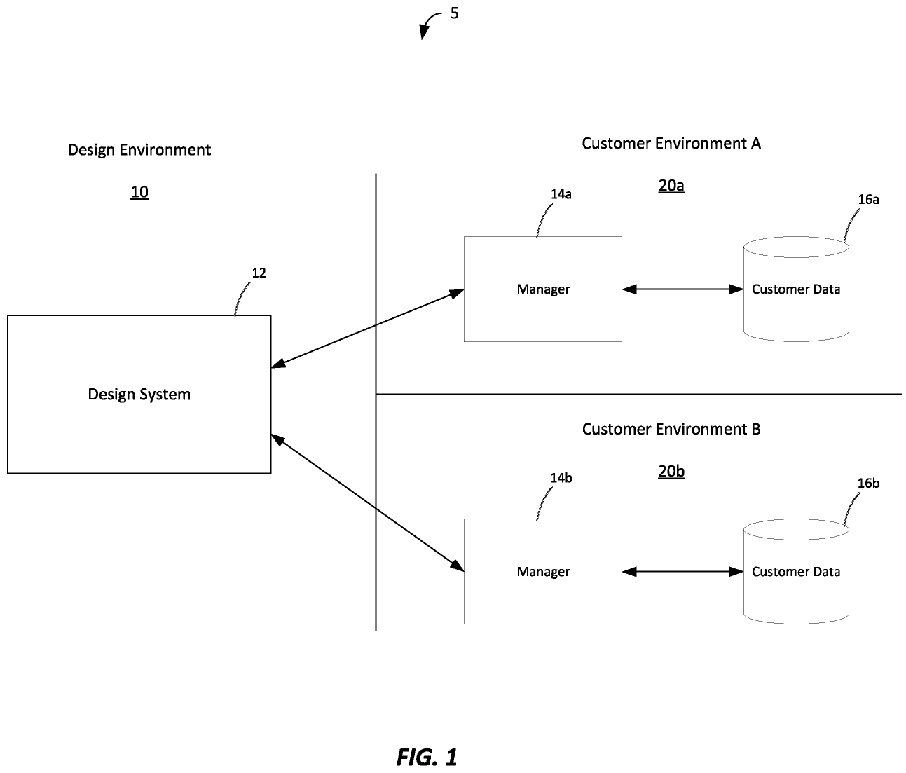

Referring now to FIG. 1, illustrated is an example environment 5 that may be used to implement the disclosed techniques. In particular, the environment 5 includes a design environment 10 and a plurality of customer environments 20. The design environment 10 may include a design system 12 be configured to assist customers in setting up their respective customer environments and/or deploying additional tools that a customer may utilize to analyze the data stored in their customer environment 20.

In one example, the design system 12 may host one or more utilities that enable a user to set up a workspace for conducting an eDiscovery task. Accordingly, the design system 12 may be configured to set up and/or configure a manager 14 of the customer 16 to include a set of analytics and/or other types of tools to support the eDiscovery task. One tool may enable the customer to ingest their private, privileged, and/or otherwise confidential data into a customer database 16. Another tool may relate to training and/or applying a machine learning model to analyze the data in the customer database 16. For example, the machine learning model may be trained to identify documents subject to a privilege claim. As another example, the machine learning model may be trained to identify communication documents exhibiting a particular sentiment.

Given the privileged nature of the customer data maintained at the customer database 16, the customer environments 20 are segregated from one another such that customers cannot access confidential data stored in another customer environment 20. Additionally, the customer environments 20 may be segregated from the design environment 10 such that customer data is not accessible to operators of the design environment 10 such that not even the design system 12 can access the confidential customer data. As a result, customer privacy is built into the design of the environment 5.

According to certain aspects, the specific goal of the analytics tools may vary between the customer environments 20. For example, the topics that indicate whether or not a document is responsive to a production request may vary. As another example, the definition of what a positive or negative sentiment actually means may vary. Thus, traditionally, the customer must spend a significant amount of time setting out specific requirements for their inquiry and identify a sufficient number of documents that representative of the intended topic, sentiment, etc. to start the training process. The models are then evaluated against a validation set of documents to determine whether a sufficient number of annotated documents have been received for the model to be properly trained. Moreover, due to the inquiry-specific nature, this means that traditionally the machine learning models that act on the customer data are trained within the customer environments 20 themselves.

One way to reduce the amount of manual annotation required to train a machine learning model is to start with a partially-trained model. Generally, partially-trained models include layers that are trained on prior data related to a similar inquiry which are then tuned to the customer-specific need later on. Thus, the partially-trained models include layers that are already generally tuned to the type of inquiry at which they are being deployed and the tuning process can add additional layers that are specific to the customer need. As a result, fewer layers need to be trained, generally resulting in fewer manual annotations needed to satisfy the validation criteria.

However, because the partially-trained models are trained on prior data, it may be possible for clever users to derive characteristics about the prior training data. For example, if the partially-trained model is applied, without modification, to a corpus of documents, then the top results may roughly indicate what data was the partially-trained model was trained upon. As a result, the privacy of the customer data upon which the partially-trained model was trained may be abrogated.

### II. Example Computing Environment

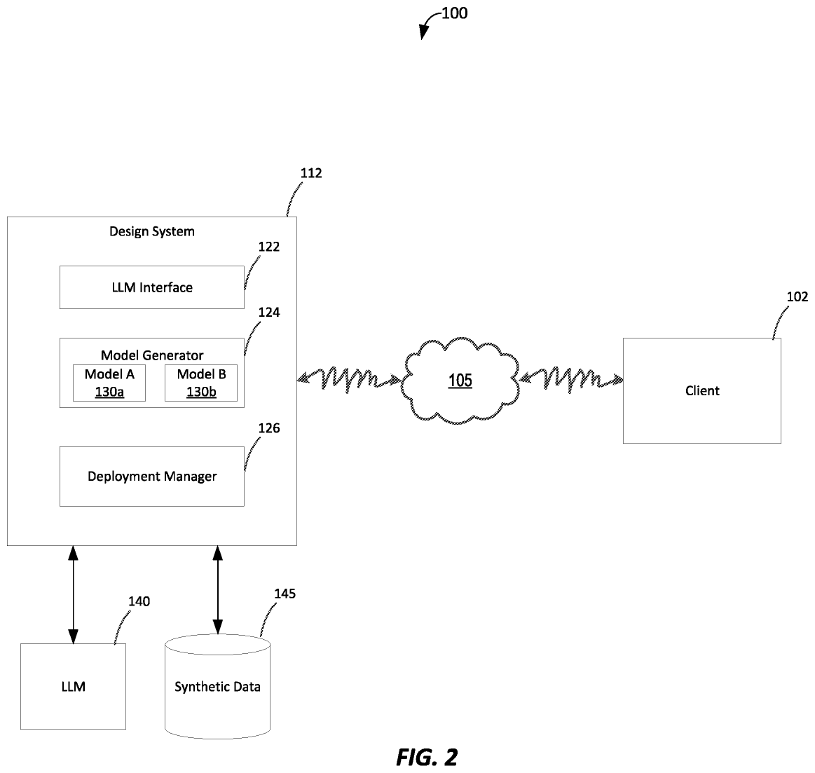

FIG. 2 depicts an example computing environment 100 that may be used to generate synthetic training data in accordance with techniques disclosed herein. Unlike conventional training data, synthetic data is generated by an LLM and is not subject to the same confidentiality concerns as conventional partially-trained models. Thus, a partially-trained model can be freely deployed without potentially exposing characteristics associated with confidential customer data.

As illustrated, the environment 100 includes a design system 112 (such as the design system 12 of FIG. 1) communicatively coupled to a client device 102 via network 105. The network 105 may be a single communication network or may include multiple communication networks of one or more types (e.g., one or more wired and/or wireless local area networks (LANs), and/or one or more wired and/or wireless wide area networks (WANs) such as the Internet). The design system 112 may be a web server, a back-end server, or any combination thereof. Additionally, while FIG. 2 shows only a single client device 102, it is understood that multiple different client devices (of different entities and/or users), each similar to the client device 102, may be in remote communication with the design system 112 via the network 105 and/or alternative networks.

As illustrated, the design system 112 may include an interface 122 with an LLM 140. The LLM 140 may be any type of LLM, such as a ChatGPT model, a Google Bard model, a Codex model, and/or any other LLM model. The LLM 140 may be hosted at a distributed computing system accessible via the LLM interface 122. In some embodiments, the LLM 140 is tuned to identify characteristics of communication documents using publicly-available datasets. For example, one public dataset of emails is the “Enron email dataset.” Based on the public datasets, the LLM 140 may be tuned to identify a message type (e.g., email, SMS, Slack message, etc.), sentiment, topics, and/or other characteristics of communication documents. This tuning process may include supervised or unsupervised machine learning techniques.

According to aspects, the LLM interface 122 may also be in communication with the client device 102 to present one or more graphical user interfaces (GUIs) for interacting with the LLM 140. Accordingly, the LLM interface 122 may act as a relay between the client device 102 and the LLM 140.

In one scenario, the user of the client device 102 may interact with LLM interface 122 to generate synthetic data for training a machine learning model (such as a classifier). More particularly, the user of the client device 102 may provide instructions to the LLM detailing the particular type of training data to generate. In some embodiments, the user of the client device 102 may be associated with a provider of support services for document review projects (such as eDiscovery, communication monitoring, etc.). Accordingly, the user may specify a problem statement associated with content of the generated data (e.g., a positive or negative sentiment, the inclusion of a particular topic, etc.) and/or context to inject the generated data (e.g., business vs. personal communications, a particular mode of communication (such as email, Slack message, text message, etc.), and/or other characteristics of documents). Generally, the goal is to create a corpus of synthetic data that has characteristics that are similar to a corpus of customer data at which a model is trained on the synthetic data is expected to be deployed.

In response, the LLM interface 122 may provide the inputs to the LLM 140 to obtain a set of example training data that the LLM 140 believes complies with the received instructions. The LLM interface 122 may then present the results via the GUI. In addition to presenting the results, the LLM interface 122 may present the ability for the user to provide feedback on the responsiveness of the results. For example, the user may indicate which results were responsive/unresponsive, request more or fewer results like a particular result, a quantitative and/or qualitative score associated with each result, and/or other types of feedback.

By providing the feedback, the user is able to tune the LLM 140 to provide the specific types of training data to meet a particular need. As a result, the generated synthetic data can be tailored to the specific goals for the corpus of synthetic data. After the user is confident that the LLM 140 is consistently providing quality synthetic data for the particular inquiry, the user may request the LLM 140 to generate a batch of synthetic training data of a specified size (e.g., such that the matching type of documents is a predetermined proportion of the corpus of synthetic data). The design system may store any generated synthetic data in a synthetic data database 145.

The user may also interface with the LLM 140 to generate synthetic data that is non-responsive and/or neutral to the problem statement such that a model has counter examples to utilize during training. Accordingly, the user may perform a similar iterative process to generate examples of the other types of synthetic data to include in the corpus of synthetic data. After the user is satisfied with the composition of the corpus of synthetic data maintained at the synthetic data database 145, the user may then begin the process of training a model using the synthetic data.

As illustrated, the design system 112 also include a model generator 124 for training a model based on the synthetic training data. Accordingly, the model generator 124 may execute an embedding model to extract features of the synthetic data included in the corpus of synthetic data. For example, the model generator 124 may utilize an n-gram embedding model, a doc2vec embedding model, a bi-directional encoder representations from transformers (BERT) model, and so on. The model generator 124 may then combine the embeddings for the synthetic data to generate an embedding space to utilize for training one or more models 130.

It should be appreciated that the model generator 124 may generate any number of models 130 using the embedding space. For example, a model 130a may be a support vector machine (SVM) model configured to segment the embedding space using a hyperplane and a model 130b may be class-based ranking model configured to identify search results based upon the embedding space. As a result, the model generator 124 is able to partially-train the models 130 for deployment in a customer environment without the risk of exposing client confidential data to third parties.

As illustrated, the design system 112 also includes a deployment manager 126 configured to enable the user of the client device 102 to import the models 130 into one or more customer environments. For example, a user of the client device 102 (or a different client device) may need to set up a new customer environment for a new project. Accordingly, the user may interface with the deployment manager 126 to specify a particular customer environment to which the specified model 130 should be imported. In response, the deployment manager 126 may provide data associated with the model 130 and/or the corpus of synthetic data to a manager of the customer environment (such as a manager 14 of FIG. 1) for integration with the utilities provided thereat.

It should be appreciated that in some embodiments, the customer environment may utilize a different embedding model than the embedding model utilized by the model generator 124. For example, customer environments may include millions of documents. Thus, the customer environment may need to utilize embedding model that is particularly suited for rapid embedding to be able to embed the full corpus of customer data in a timely manner. Accordingly, in these embodiments, the deployment manager may apply a logistic regression model to the data representative of the model 130 to map the embedding space for the corpus of synthetic data 145 into the embedding space utilized in the customer environment.

In some scenarios, a custodian of the confidential data maintained in the customer environment may then interface with the manager to tune the partially-trained models 130 using the confidential data maintained thereat. In other scenarios, the customer environment is associated with a provider of support services for a document analysis project (e.g., a legal services management company). In these scenarios, the customer may want to further train the models 130 and/or develop multiple models based off of a given model 130 to be more suited to their client base (e.g., they have a set of clients that specialize in particular technological areas). Accordingly, the customer may utilize an additional client device (not depicted) to communicate with the design system 112 to generate additional synthetic training data.

More particularly, the client device of the customer may interface with the LLM interface 122 to generate additional synthetic training data that reflects the more particular contexts for their customer base (e.g., includes details that are particular to the one or more technological area supported by the customer). Because the base model 130 was already trained via the design system 112, the design system 112 is able to identify the embedding model applied to embed the corpus of synthetic data to generate the embedding space for the model 130. Thus, when the client device of the customer interfaces with the model generator 124 to re-train the model 130 using the additional synthetic data, the model generator 124 may apply the same embedding model to incorporate the additional synthetic data into the embedding space.

After the model 130 is re-trained to generate one or more additional models, the client device of the customer may then interface with the deployment manager 126 to receive the re-trained models 130 in their customer workspace. Through this process, the customer is able to generate partially-trained models that are adapted to their specific client base such that when one of their clients need to create a new workspace, the partially-trained models can be tuned to their particular inquiry with even fewer manual annotations.

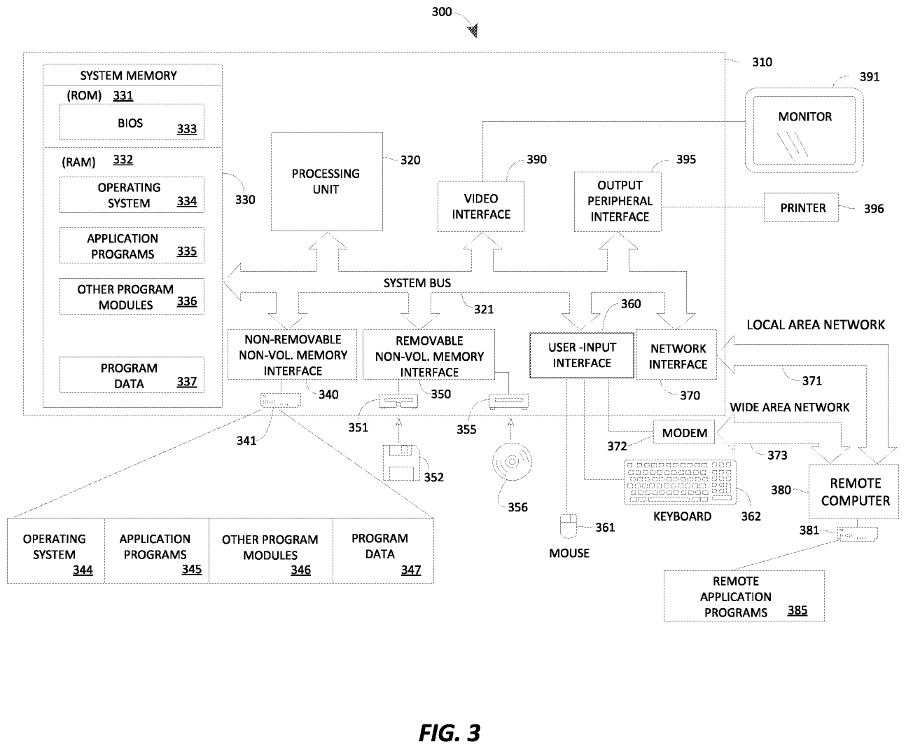

Turning now to FIG. 3, FIG. 3 depicts an example computing system 300 in which the techniques described herein may be implemented, according to an embodiment. For example, the computing system 300 of FIG. 3 may be a computing system configured to implement the design systems 12 or 112 of FIGS. 1 and 2, respectively. The computing system 300 may include a computer 310. Components of the computer 310 may include, but are not limited to, a processing unit 320, a system memory 330, and a system bus 321 that couples various system components including the system memory 330 to the processing unit 320. In some embodiments, the processing unit 320 may include one or more parallel processing units capable of processing data in parallel with one another. The system bus 321 may be any of several types of bus structures including a memory bus or memory controller, a peripheral bus, or a local bus, and may use any suitable bus architecture. By way of example, and not limitation, such architectures include the Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 310 may include a variety of computer-readable media. Computer-readable media may be any available media that can be accessed by computer 310 and may include both volatile and nonvolatile media, and both removable and non-removable media. By way of example, and not limitation, computer-readable media may comprise computer storage media and communication media. Computer storage media may include volatile and nonvolatile, removable and non-removable media implemented in any method or technology for storage of information such as computer-readable instructions, data structures, program modules or other data. Computer storage media may include, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 310.

Communication media typically embodies computer-readable instructions, data structures, program modules or other data in a modulated data signal such as a carrier wave or other transport mechanism, and may include any information delivery media. The term “modulated data signal” means a signal that has one or more of its characteristics set or changed in such a manner as to encode information in the signal. By way of example, and not limitation, communication media may include wired media such as a wired network or direct-wired connection, and wireless media such as acoustic, radio frequency (RF), infrared and other wireless media. Combinations of any of the above are also included within the scope of computer-readable media.

The system memory 330 may include computer storage media in the form of volatile and/or nonvolatile memory such as read only memory (ROM) 331 and random access memory (RAM) 332. A basic input/output system 333 (BIOS), containing the basic routines that help to transfer information between elements within computer 310, such as during start-up, is typically stored in ROM 331. RAM 332 typically contains data and/or program modules that are immediately accessible to, and/or presently being operated on, by processing unit 320. By way of example, and not limitation, FIG. 3 illustrates operating system 334, application programs 335, other program modules 336, and program data 337. For example, the application programs 335, the program modules 336 and/or the program 337 may include an LLM interface, a model generator, and/or a deployment manager.

The computer 310 may also include other removable/non-removable, volatile/nonvolatile computer storage media. By way of example only, FIG. 3 illustrates a hard disk drive 341 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 341 may be connected to the system bus 321 through a non-removable memory interface such as interface 340, and magnetic disk drive 351 and optical disk drive 355 may be connected to the system bus 321 by a removable memory interface, such as interface 350.

The drives and their associated computer storage media discussed above and illustrated in FIG. 3 provide storage of computer-readable instructions, data structures, program modules and other data for the computer 310. In FIG. 3, for example, hard disk drive 341 is illustrated as storing operating system 344, application programs 345, other program modules 346, and program data 347. Note that these components can either be the same as or different from operating system 334, application programs 335, other program modules 336, and program data 337. Operating system 344, application programs 345, other program modules 346, and program data 347 are given different numbers here to illustrate that, at a minimum, they are different copies. A user may enter commands and information into the computer 310 through input devices such as cursor control device 361 (e.g., a mouse, trackball, touch pad, etc.) and keyboard 362. A monitor 391 or other type of display device is also connected to the system bus 321 via an interface, such as a video interface 390. In addition to the monitor, computers may also include other peripheral output devices such as printer 396, which may be connected through an output peripheral interface 395.

The computer 310 may operate in a networked environment using logical connections to one or more remote computers, such as a remote computer 380. The remote computer 380 may be a personal computer, a server, a router, a network PC, a peer device or other common network node, and may include many or all of the elements described above relative to the computer 310, although only a memory storage device 381 has been illustrated in FIG. 3. The logical connections depicted in FIG. 3 include a local area network (LAN) 371 and a wide area network (WAN) 373, but may also include other networks. Such networking environments are commonplace in hospitals, offices, enterprise-wide computer networks, intranets and the Internet.

When used in a LAN networking environment, the computer 310 is connected to the LAN 371 through a network interface or adapter 370. When used in a WAN networking environment, the computer 310 may include a modem 372 or other means for establishing communications over the WAN 373, such as the Internet. The modem 372, which may be internal or external, may be connected to the system bus 321 via the input interface 360, or other appropriate mechanism. The communications connections 370, 372, which allow the device to communicate with other devices, are an example of communication media, as discussed above. In a networked environment, program modules depicted relative to the computer 310, or portions thereof, may be stored in the remote memory storage device 381. By way of example, and not limitation, FIG. 3 illustrates remote application programs 385 as residing on memory device 381.

The techniques for generating synthetic training data and training a machine learning model based thereupon described herein may be implemented in part or in their entirety within a computing system such as the computing system 300 illustrated in FIG. 3. In some embodiments, the computing system 300 is a server computing system communicatively coupled to a local workstation (e.g., a remote computer 380) via which a user interfaces with the computing the computing system 300. For example, the computer 310 may be configured to present one or more user interfaces at a local workstation (e.g., a client device) for presentation thereat to receive natural language inputs requesting a particular type of synthetic data be generated by the LLM and/or to present the generated synthetic data.

In some embodiments, the computing system 300 may include any number of computers 310 configured in a cloud or distributed computing arrangement. Accordingly, the computing system 300 may include a cloud computing manager system (not depicted) that efficiently distributes the performance of the functions described herein between the computers 310 based on, for example, a resource availability of the respective processing units 320 or system memories 330 of the computers 310. In these embodiments, the documents in the corpus of synthetic data and/or the data configured to implement a trained machine learning model may be stored in a cloud or distributed storage system (not depicted) accessible via the interfaces 371 or 373. Accordingly, the computer 310 may communicate with the cloud storage system to access the documents within the corpus of documents, for example, when generating an embedding vector as part of the model training process.

### III. Example User Interface

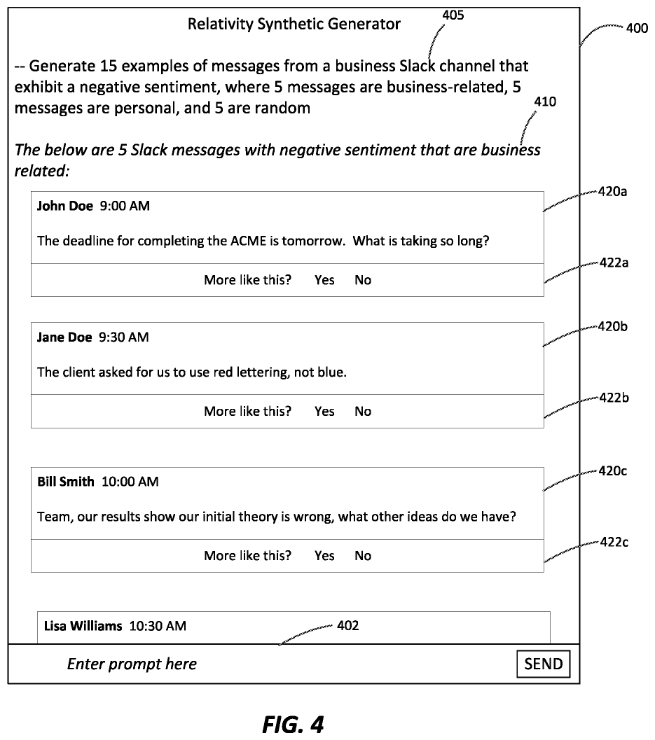

FIG. 4 illustrates an example user interface 400 associated with generating synthetic training data using an LLM. The user interface 400 may be displayed on a client device, such as the client device 102 of FIG. 2. More particularly, the client device may interface with a LLM interface (such as the LLM interface 122) of a design system (such as the design system 112 of FIG. 2) to present the example user interface 400.

The example user interface 400 includes a text entry portion 402 via which the user is able to provide natural language inputs requesting that a LLM (such as the LLM 140) perform a requested task, such as generating synthetic data. It should be appreciated that while the instant techniques are generally focused on the ability of the LLM to generate synthetic training data, the user may request the LLM to perform other functions (such as specifying the types of models generated by the design system, validating the trained models, and/or how to deploy the trained models). In response to the user submitting a request, the client device transmits the text from the text entry portion 402 to the design system which inputs the text into the LLM.

In the illustrated scenario, the user provided a prompt 405 requesting the LLM to generate fifteen examples of messages from a business Slack channel that exhibit a negative sentiment, where five messages are business-related, five messages are personal, and five are random. Accordingly, the request indicates a number of synthetically-generated messages, a message channel to replicate (e.g., Slack messages), a type of communication (e.g., personal vs. business), and a sentiment (positive vs. negative sentiment). In other scenarios, the user may specify other aspects of the synthetic data, such as a topic, a role for a speaker, a familial relationship between the messages (e.g., messages part of the same conversation, channel, email chain, etc.), and/or other characteristics a user can envision being pertinent to an inquiry.

In response to the prompt 405, the LLM generated synthetic messages that comply with the characteristics indicated by the prompt 405. The LLM interface then presents the outputs via the user interface 400. In the illustrated example, the output includes a text output 410 indicating the intended characteristics of the synthetic messages and the synthetic messages 420. Accordingly, the user is able to review the synthetic messages 420 to confirm that the synthetic messages conform to the prompt 405.

Additionally, the LLM interface may configure the user interface 400 to include user interface element 422 that enable the user to provide feedback on the synthetic messages 420. For example, the user can indicate their dissatisfaction with a synthetic message 420 by selecting the “no” button associated with a given synthetic message. On the other hand, if the user is satisfied with a synthetic message 420, the user can select the “yes” button. The LLM interface may send the feedback provided via the feedback elements 422 to the LLM to update the generative models. As a result, the feedback can be used to tune the LLM to be able to better generate synthetic messages 420 of the type the user wants to generate. Accordingly, when the user provides another prompt via the text entry interface 402 to generate additional synthetic messages, the messages are more likely to conform to the requested characteristics.

It should be appreciated that the user interface 400 is just one example user interface in which the disclosed techniques are implemented. Other user interfaces may include additional, fewer, or alternate user interface elements than those illustrated in FIG. 4.

### IV. Example Methods

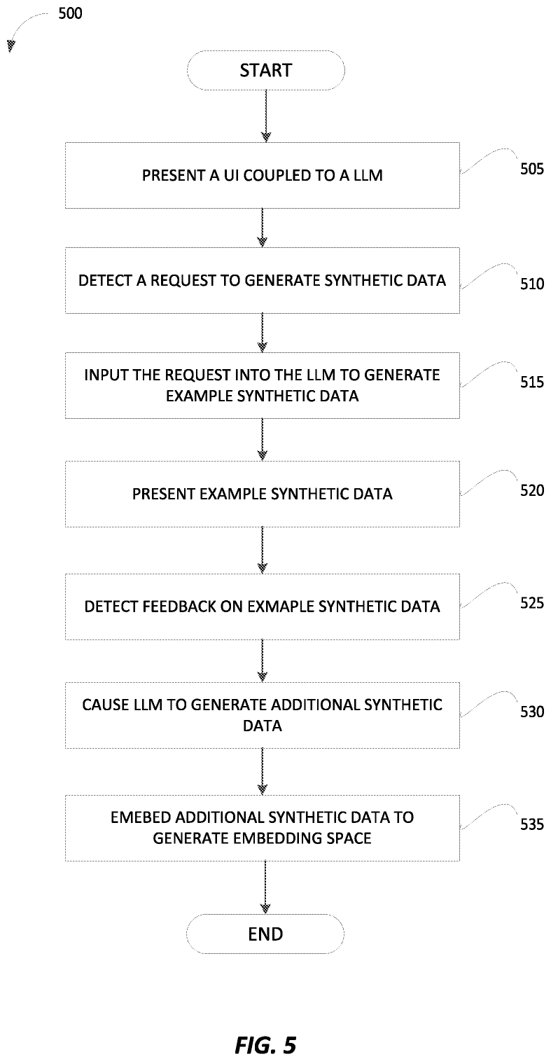

FIG. 5 depicts a flow diagram of an example method 500 for generating synthetic data to train a machine learning model in accordance with the techniques described herein. The method 500 may be implemented by one or more processors of one or more computing devices, such as the design systems 12 and 112 of FIGS. 1 and 2 or the computing system 300 of FIG. 3, for example.

The method 500 may begin when the computing system presents a user interface coupled to a large language model (LLM) (such as the LLM 140 of FIG. 2) via which a user interfaces with the LLM (block 505). In some embodiments, the computing system executes a LLM interface (such as the LLM interface 122 of FIG. 2) to provide the UI. As one example, the user interface may be the example user interface 400 of FIG. 4.

At block 510, the computing system detects a request to generate synthetic data. In some embodiments, the request indicates one or more characteristics of the synthetic data. In one example, the computing system detects a prompt submitted via the text entry portion 402 of the user interface 400. In some embodiments, the characteristics of the synthetic data may include one or more of a sentiment conveyed by the synthetic data, a topic referenced by the synthetic data, a format for the synthetic data (e.g., a file format, a communication channel, etc.), or a domain associated with the synthetic data (e.g., personal, business, legal, etc.). Additionally or alternatively, the request may indicate a number of examples to include in the example synthetic data.

At block 515, the computing system inputs the request into the LLM to generate example synthetic data having the one or more characteristics. For example, the LLM interface may provide the prompt detect via the text entry portion 402 into the LLM. In response, the LLM may generate example synthetic data that is intended to exhibit the requested characteristics and provide the example synthetic data back to the LLM interface.

At block 520, the computing system presents the example synthetic data via the user interface. For example, the computing system may present the example synthetic data in a manner similar to the indications of the example synthetic data 420 of FIG. 4. In some embodiments, the computing system may also present one or more elements that enable the user to provide the feedback as to a responsiveness of the example synthetic data to the one or more characteristics indicated by the request. For example, the computing system may provide the user interface elements 422 of FIG. 4.

At block 525, the computing system detects feedback on the example synthetic data. For example, the user may have interacted with one of the user interface elements 422.

At block 530, the computing system causes the LLM to generate additional synthetic data based upon the feedback. For example, the LLM interface may provide the feedback to the LLM to tune characteristic generation layers of the LLM to more accurately reflect the user's intent. That is, the user feedback may provide positive or negative reinforcement with respect to the characteristics included in the example synthetic data. Thus, when the user requests that the LLM generates additional synthetic data, the additional synthetic data more accurately reflect the requested characteristics. In some embodiments, the computing system may repeat the steps associated with the blocks 510 to 530 to generate additional synthetic data having a different set of one or more characteristics. In these embodiments, the corpus of synthetic data may generally reflect characteristics of a corpus of customer data to which the classifier is expected to be applied.

At block 535, the computing system embeds the additional synthetic data to generate an embedding space for training a classifier (such as the models 130 of FIG. 2). For example, the classifier may be (i) configured to identify documents most closely related to an inquiry (e.g., such a class-rank classifier used in a search), or (ii) configured to segment the embedding space into two or more segments (e.g., a SVM model that generates a hyperplane in the embedding space). In some embodiments, the computing system may execute a model generator (such as the model generator 124 of FIG. 2) to train the classifier.

In some embodiments, the computing system may validate whether the classifier is sufficiently trained. To this end, the computing system may validate the classifier against one or more validation criteria (e.g., a precision threshold, an accuracy threshold, a recall threshold, an elusion threshold, etc.) when applied against a validation set of data. If the computing system determines that the classifier does not satisfy the validation criteria, the computing system may then cause the LLM to generate further additional synthetic data to further train the classifier. The further additional synthetic data may include the one or more characteristics associated with a prior request and/or exhibit different characteristics in proportion to the similar type of synthetic data in the corpus of synthetic data.

After the classifier is trained, the computing system may detect a request to provide the classifier to a customer environment (such a customer environment 20 of FIG. 1). In some embodiments, the computing system may execute a deployment manager (such as the deployment manager 126 of FIG. 2) to provide the classifier to a manager (such as a manager 14 of FIG. 1) of the customer environment. As part of providing the classifier, the computing system may map the embedding space into a second embedding space generated for a corpus of customer data included in the customer environment (such as a customer database 16 of FIG. 1). For example, the corpus of customer data may include documents that are privileged and/or confidential. If the second embedding space uses a different embedding model, the computing system may apply a logistic regression to map the embedding space into the second embedding space. At this point, the computing system and/or the manager may then tune the classifier to the customer data by further training the classifier using the customer data.

As described above, the trained classifier may be considered a partially-trained model. In some embodiments, a legal support service provider may want to generate one or more versions of the classifier that are tuned to have one or more additional characteristics. As a result, the legal support service provider may be able to provide a set of partially-trained models adapted to different expected workflows. To support this functionality, the computing system may be configured to (1) present second user interface coupled to the LLM to a second user (such as a user of the legal support service provider), (2) detect, via the second user interface, a second request to generate synthetic data, the second request indicating one or more second characteristics of the synthetic data; (3) input the request into the LLM to generate second synthetic data having the one or more second characteristics; and (4) embed the second synthetic data to incorporate the embedded second synthetic data into the embedding space for tuning the classifier.

### V. Additional Considerations

The following additional considerations apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for identifying and grouping likely textual near-duplicates through the principles disclosed herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed:

1. A method for generating synthetic data to train a machine learning model, the method comprising:
presenting, via one or more processors, a user interface coupled to a large language model (LLM) via which a user interfaces with the LLM;
detecting, via the user interface, a request to generate synthetic data, the request indicating one or more characteristics of the synthetic data;
inputting, via the one or more processors, the request into the LLM to generate example synthetic data having the one or more characteristics;
presenting, via the user interface, the example synthetic data;
detecting, via the user interface, feedback on the example synthetic data;
causing, via the one or more processors, the LLM to generate additional synthetic data based upon the feedback; and
embedding, via the one or more processors, the additional synthetic data to generate an embedding space for training a classifier.

2. The method of claim 1, wherein the one or more characteristics include one or more of a sentiment conveyed by the synthetic data, a topic referenced by the synthetic data, a format for the synthetic data, or a domain associated with the synthetic data.

3. The method of claim 1, wherein the request indicates a number of examples to include in the example synthetic data.

4. The method of claim 1, wherein presenting the example synthetic data comprises:
presenting, via the user interface, one or more elements that enable the user to provide the feedback as to a responsiveness of the example synthetic data to the one or more characteristics indicated by the request.

5. The method of claim 1, wherein the classifier is (i) configured to identify documents most closely related to an inquiry, or (ii) configured to segment the embedding space into two or more segments.

6. The method of claim 1, further comprising:
mapping, via the one or more processors, the embedding space into a second embedding space generated for a corpus of documents; and
tuning, via the one or more processors, the classifier based upon the second embedding space.

7. The method of claim 6, wherein the corpus of documents includes privileged and/or confidential information.

8. The method of claim 6, wherein mapping the embedding space into the second embedding space comprises:
applying, via the one or more processors, a logistic regression.

9. The method of claim 1, further comprising:
validating, via the one or more processors, the classifier against one or more validation criteria;
determining, via the one or more processors, that the classifier does not satisfy the one or more validation criteria; and
causing, via the one or more processors, the LLM to generate further additional synthetic data.

10. The method of claim 1, further comprising:
presenting, via the one or more processors, a second user interface coupled to the LLM to a second user;
detecting, via the second user interface, a second request to generate synthetic data, the second request indicating one or more second characteristics of the synthetic data;
inputting, via the one or more processors, the request into the LLM to generate second synthetic data having the one or more second characteristics; and
embedding, via the one or more processors, the second synthetic data to incorporate the embedded second synthetic data into the embedding space for tuning the classifier.

11. A system for generating synthetic data to train a machine learning model, the system comprising:
one or more processors; and
one or more memories storing non-transitory, computer-readable instructions that, when executed by the one or more processors, cause the system to:
present a user interface coupled to a large language model (LLM) via which a user interfaces with the LLM;
detect, via the user interface, a request to generate synthetic data, the request indicating one or more characteristics of the synthetic data;
input the request into the LLM to generate example synthetic data having the one or more characteristics;
present the example synthetic data;
detect, via the user interface, feedback on the example synthetic data;
cause the LLM to generate additional synthetic data based upon the feedback; and
embed the additional synthetic data to generate an embedding space for training a classifier.

12. The system of claim 11, wherein the one or more characteristics include one or more of a sentiment conveyed by the synthetic data, a topic referenced by the synthetic data, a format for the synthetic data, or a domain associated with the synthetic data.

13. The system of claim 11, wherein the request indicates a number of examples to include in the example synthetic data.

14. The system of claim 11, wherein to present the example synthetic data, the instructions, when executed, cause the system to:
present, via the user interface, one or more elements that enable the user to provide the feedback as to a responsiveness of the example synthetic data to the one or more characteristics indicated by the request.

15. The system of claim 11, wherein the classifier is (i) configured to identify documents most closely related to an inquiry, or (ii) configured to segment the embedding space into two or more segments.

16. The system of claim 11, wherein the instructions, when executed, cause the system to:
map the embedding space into a second embedding space generated for a corpus of documents; and
tune the classifier based upon the second embedding space.

17. The system of claim 16, wherein to map the embedding space into the second embedding space, the instructions, when executed, cause the system to:
apply a logistic regression.

18. The system of claim 11, wherein the instructions, when executed, cause the system to:
validate the classifier against one or more validation criteria;
determine that the classifier does not satisfy the one or more validation criteria; and
cause the LLM to generate further additional synthetic data.

19. The system of claim 11, wherein the instructions, when executed, cause the system to:
present a second user interface coupled to the LLM to a second user;
detect, via the second user interface, a second request to generate synthetic data, the second request indicating one or more second characteristics of the synthetic data;
input the request into the LLM to generate second synthetic data having the one or more second characteristics; and
embed the second synthetic data to incorporate the embedded second synthetic data into the embedding space for tuning the classifier.

20. A non-transitory computer-readable storage medium storing processor-executable instructions, that when executed cause one or more processors to:
present a user interface coupled to a large language model (LLM) via which a user interfaces with the LLM;
detect, via the user interface, a request to generate synthetic data, the request indicating one or more characteristics of the synthetic data;
input the request into the LLM to generate example synthetic data having the one or more characteristics;
present the example synthetic data;
detect, via the user interface, feedback on the example synthetic data;
cause the LLM to generate additional synthetic data based upon the feedback; and
embed the additional synthetic data to generate an embedding space for training a classifier.
